(19) United States
(12) Patent Application Publication
(10) Pub. No.: US 2008/0261527 A1
(43) Pub. Date: Oct. 23, 2008

(54) Bluetooth earpiece with two-way audio transmissions

(76) Inventor: Lu-Cheng Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/213,126

(22) Filed: Jun. 16, 2008

Related U.S. Application Data
(63) Continuation-in-part of application No. 11/166,072, filed on Jun. 27, 2005.

(51) Int. Cl. H04B 7/00

(52) U.S. Cl. 455/41.2

(57) ABSTRACT

A Bluetooth earpiece with two-way audio transmissions adopts a base body combined with a Bluetooth earphone containing a signal transmitting end. An electrically connected amplifying unit, loudspeaker unit and audio signal capture unit are installed in the base body. The amplifying unit electrically connects to signal transmitting end of the Bluetooth earphone while the Bluetooth earphone is inserted in the base body. The Bluetooth earphone is capable of receiving audio information from a remote end and sending the information to the loudspeaker unit of the Bluetooth earpiece through an audio transmission switching unit in the Bluetooth earphone to produce sounds. In the meantime, users can receive the sounds by the audio signal capture unit of the Bluetooth earpiece, and the captured audio information is sent to the Bluetooth earphone through the amplifying unit to complete the two-way audio transmission.

This application is a Continuation-in-Part of application Ser. No. 11/166,072 filed on 27 Jun. 2005, and entitled BLUETOOTH EARPIECE WITH TWO-WAY AUDIO TRANSMISSIONS.

### BACKGROUND OF THE INVENTION

1. Field of the Invention

The present invention relates to a Bluetooth earpiece integrated with a Bluetooth earphone for automatically switching two-way audio transmissions.

2. Description of Related Art

Bluetooth is a low-cost, low-power and short-distance wireless communication technology extensively used in all kinds of mobile communication devices. The Bluetooth technology wireless transmission function is used in the design of Bluetooth earphones, portable mobile phone watches, and communication devices that can be worn directly on the fingers. The built-in Bluetooth chip of these products not only can perform wireless transmissions, but also can provide user-friendly functions such as logging onto the Internet and sending/receiving E-mail.

Various kinds of Bluetooth earphones are sold in the market, and most are used together with a Bluetooth mobile phone. Users can wear the Bluetooth earphone and communicate with others on a standard frequency. Regardless of the time and place, a user can use the wireless transmission function of the Bluetooth technology to receive a phone call with a hands-free effect.

Reference is made to FIG. 1 for the communication architecture between a prior art Bluetooth earphone and a Bluetooth mobile phone. In the prior art Bluetooth communication architecture, the audio information 20 of an incoming call from a Bluetooth mobile phone 30 is sent to a Bluetooth earphone 10 via wireless transmissions, and the desired audio information 22 is sent to the Bluetooth mobile phone 30 by the Bluetooth earphone 10 via wireless transmissions by the Bluetooth communication technology for two-way audio transmissions. Therefore, a user can receive phone calls in different places without holding the mobile phone.

Reference is made to FIG. 2 together with FIG. 1 for the schematic circuit block diagram of a prior art Bluetooth earphone. If there is an incoming call, a wireless communication unit 101 in the Bluetooth earphone 10 will receive the audio information 20 transmitted from a Bluetooth mobile phone 30 at a remote end, and the incoming audio information 20 will be sent to a digital signal processor 102 for processing. An audio transmission encoder/decoder 106 in the digital signal processor 102 decodes the audio information 20 and sends the information from the earphone 104, so that a user can hear it clearly.

In the meantime, a user can use a microphone 103 to reply and send the audio information 22 to the audio transmission encoder/decoder 106 in the digital signal processor 102. After the reply audio information 22 is sent to the wireless communication module 101 and is encoded by the audio transmission encoder/decoder 106, the wireless communication module 101 sends the replied audio information 22 to a Bluetooth mobile phone 30 at a remote end to complete the two-way audio transmissions. The invention allows a user to receive a phone call at any place and achieves the hands-free effect of the mobile phone.

However, if there is an incoming call, the Bluetooth earphone 10 can only provide a user with call reception, and does not allow telephone communication for three or more parties. Therefore, the quality and requirements of telephone communication for our daily life or work will become inferior.

### SUMMARY OF THE INVENTION

The present invention provides a Bluetooth earpiece with two-way audio transmissions that can be combined with a Bluetooth earphone, so as to switch automatically the transmission path of the audio information. The two-way audio transmission is accomplished by a loudspeaker unit and an audio signal capture unit in Bluetooth earpiece.

The Bluetooth earpiece with two-way audio transmissions in accordance with the present invention adopts a base body had an earphone receiving slot to contain a Bluetooth earphone. Moreover, the Bluetooth earphone further comprises an metallic element, and a magnetic element in the earphone receiving slot, the magnetic element attracts the metallic element of the Bluetooth earphone when the Bluetooth earphone approaches the earphone receiving slot. The Bluetooth earphone is connected to a signal transmitting end by an audio transmission switching unit. The base body has an amplifying unit, a loudspeaker unit and an audio signal capture unit, which are electrically connected to each other. The amplifying unit is electrically connected to a signal transmitting end of the Bluetooth earphone when the Bluetooth earphone is inserted in the earphone receiving slot of the base body. The audio information from a remote end received by the Bluetooth earphone will be sent to the loudspeaker unit in the Bluetooth earpiece to produce sounds through the signal transmitting end of an audio transmission switching unit in the Bluetooth earphone. In the meantime, a user can use the audio signal capture unit in the Bluetooth earpiece to receive sounds, and the captured audio information is sent to the Bluetooth earphone through the signal transmitting end, so as to complete the two-way sound transmissions.

The earpiece of the present invention adopts the magnetic attracting effect generated by the magnetic element for attracting the metallic element of the Bluetooth earphone so as to integrate with the Bluetooth earphone rapidly.

Moreover, the earpiece of the present invention amplifies the sound of the audio information received by a remote mobile phone by the loudspeaker unit of the Bluetooth earphone, so that users can hear the sound clearly. In the meantime, the present invention uses an audio signal capture unit to send the audio information replies made by several parties to the Bluetooth earphone and send such information to a remote mobile phone through the Bluetooth earphone, so as to complete the two-way sound transmissions. Therefore, the present invention allows users to have telephone communication for three or more parties, and improve the quality and requirements of telephone communication for daily life and work.

To make it easier for our examiner to understand the innovative features and technical content, we use a preferred embodiment together with the attached drawings for the detailed description of the invention, but it should be pointed out that the attached drawings are provided for reference and description but not for limiting the present invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a view of the communication architecture between a prior art Bluetooth earphone and a Bluetooth mobile phone;

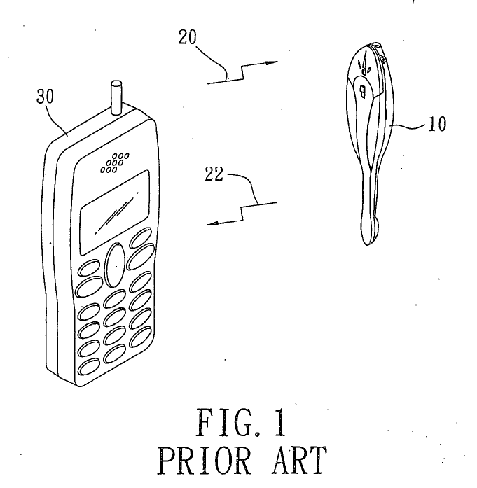

FIG. 2 is a schematic circuit block diagram of a prior art Bluetooth earphone;

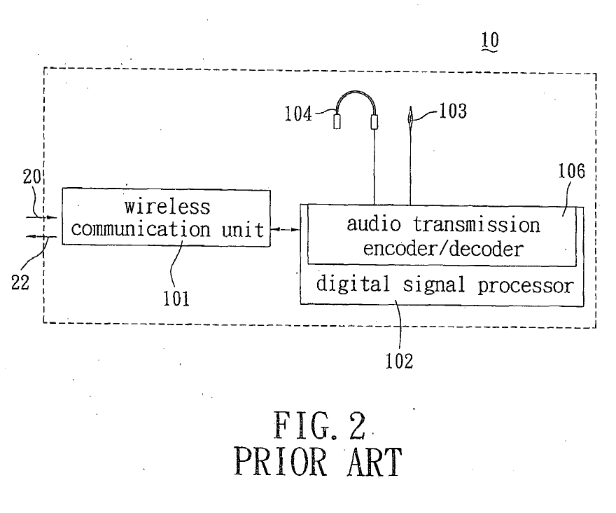

FIG. 3 is a schematic perspective view of a Bluetooth earphone of the present invention;

FIG. 4 is a perspective view of a Bluetooth earphone of the present invention;

FIG. 5 is a schematic circuit block diagram of a Bluetooth earpiece being combined with a Bluetooth earphone according to the present invention;

FIG. 6 is a schematic circuit diagram of a Bluetooth earphone of the present invention; and

FIG. 7 is a schematic circuit diagram of a Bluetooth earpiece with a two-way audio transmission function.

### DETAILED DESCRIPTION OF PREFERRED EMBODIMENTS

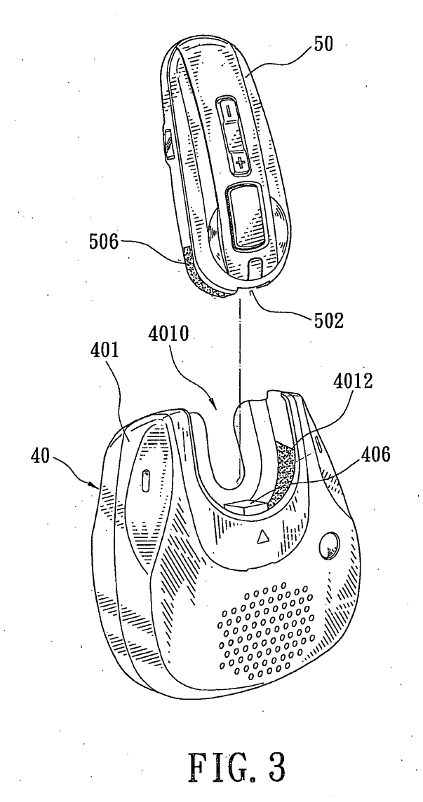

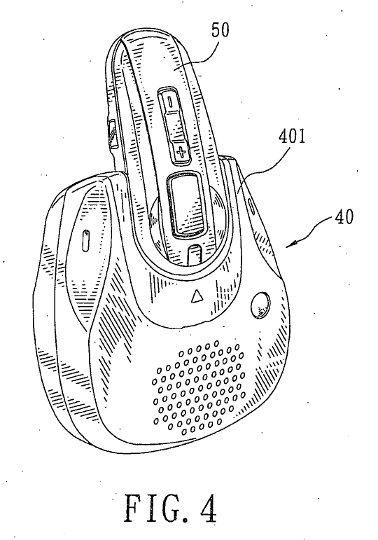

Reference is made to FIG. 3 for the schematic view of a Bluetooth earpiece and a Bluetooth earphone in accordance with the present invention. The Bluetooth earpiece 40 with two-way audio transmissions of the invention is combined with a Bluetooth earphone 50 for use thereof. Reference is made to FIG. 4 for the schematic view of the Bluetooth earpiece combined with a Bluetooth earphone according to the invention. The Bluetooth earpiece 40 with two-way audio transmissions includes a base body 401, which has an earphone receiving slot 4010 used for accommodating the Bluetooth earphone 50.

Reference is made to FIG. 3 again. In order to rapidly connect the Bluetooth earphone 50 with the base body 401, the Bluetooth earphone 50 further includes an metallic element 506, and a magnetic element 4012 in the earphone receiving slot 4010 of the base body 401. When the Bluetooth earphone 50 approaches the earphone receiving slot 4010 of the base body 401, the magnetic attracting effect generated by the magnetic element 4012 attracts the metallic element 506 of the Bluetooth earphone 50. Thereby, the Bluetooth earphone 50 is rapidly received in the earphone receiving slot 4010 and a signal transmitting terminal 502 of the Bluetooth earphone 50 is electrically connected with a signal connector 406 of the Bluetooth earpiece 40.

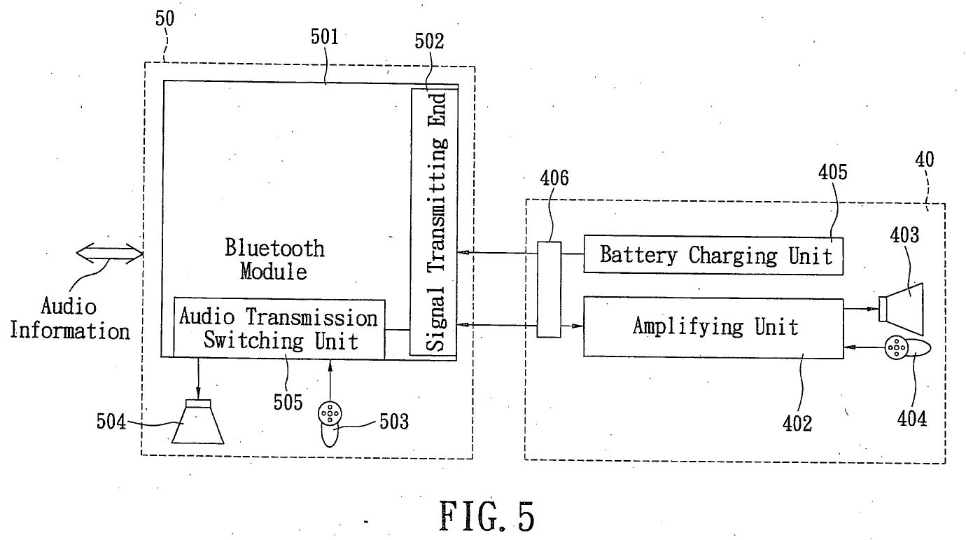

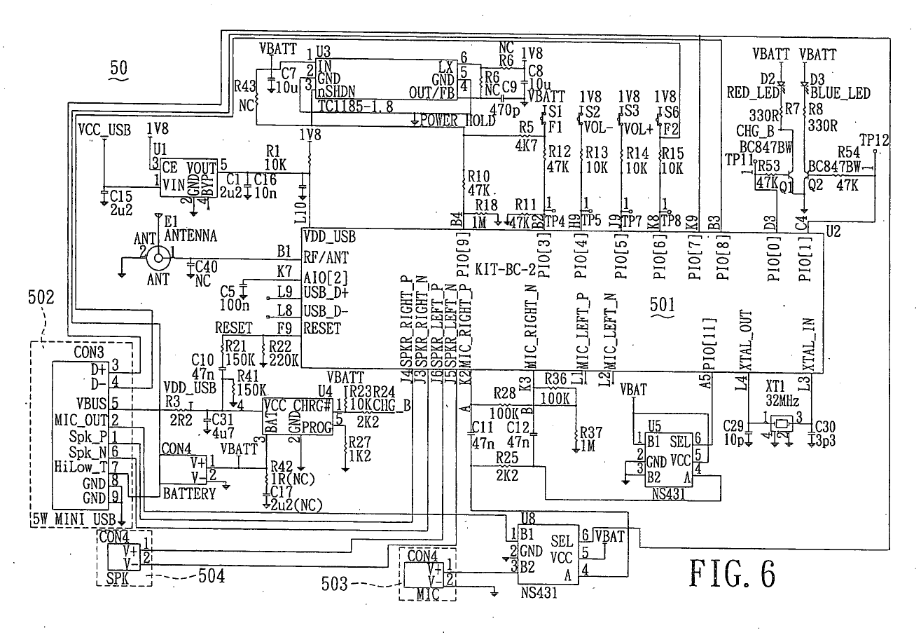

Reference is made to FIG. 5 for the schematic circuit block diagram of the Bluetooth earpiece combined with a Bluetooth earphone according to the present invention. The Bluetooth earpiece 40 with two-way audio transmissions of the invention is combined with a Bluetooth earphone 50 for use thereof. Reference is made to FIG. 6 at the same time. FIG. 6 shows a schematic circuit diagram of the Bluetooth earphone of the invention. The Bluetooth earphone 50 comprises a Bluetooth module 501, a signal transmitting end 502, an earphone 504, an audio transmission switching unit 505 and a microphone 503. The Bluetooth earphone 50 is electrically connected to the signal connector 406 of the Bluetooth earpiece 40 with two-way audio transmissions through the signal transmitting end 502.

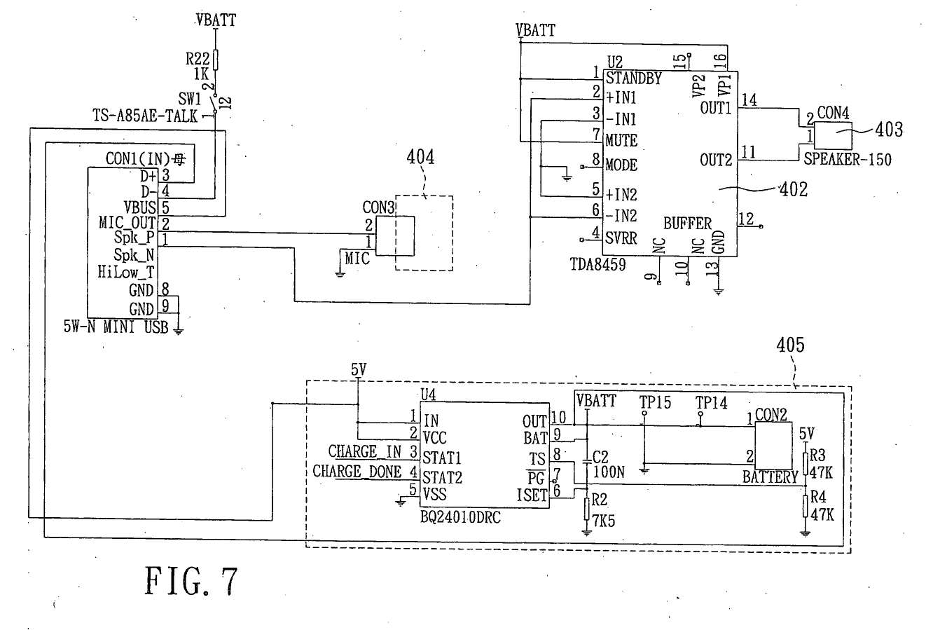

Reference is made to FIGS. 5 and 7, in which FIG. 7 shows a schematic circuit diagram of a Bluetooth earpiece with two-way audio transmissions in accordance with the present invention. The circuit unit in the base body 401 (as shown in FIG. 4) of the Bluetooth earpiece 40 with two-way audio transmissions comprises an amplifying unit 402, a loudspeaker unit 403 and an audio signal capture unit 404. The amplifying unit 402 is electrically connected to the signal transmitting end 502 of the Bluetooth earphone 50 via the signal connector 406, when the Bluetooth earphone 50 is inserted in the base body 401 of the Bluetooth earpiece 40 with two-way audio transmissions. The loudspeaker unit 403 and the audio signal capture unit 404 are electrically connected with the amplifying unit 402.

If the Bluetooth earphone 50 receives audio information from a remote end, the audio transmission switching unit 505 will automatically switch the transmission path of the audio information, and the information is transmitted by the loudspeaker unit and the audio signal capture unit 404 in the Bluetooth earpiece 40, so as to achieve two-way sound transmissions.

Reference is made to FIG. 5 again. If the Bluetooth earphone 50 receives audio information from a remote end, the information will go through the audio transmission switching unit 505 in the Bluetooth earphone 50 for an automatic switching, and the information is sent to the loudspeaker unit 403 of the Bluetooth earpiece 40 by the signal transmitting end 502 to produce sounds. The loudspeaker unit 403 is, for example, a speaker. At the same time, a user can receive sounds from the audio signal capture unit 404. The audio signal capture unit 404 is, for example, a microphone. The audio signal capture unit 404 sends the captured audio information to the Bluetooth earphone 50 through the amplifying unit 402 to complete a two-way sound transmission.

Reference is made to FIG. 5 again. The Bluetooth earpiece 40 with two-way audio transmissions further comprises a battery charging unit 405 installed in the base body 401 (as shown in FIG. 4). The battery charging unit 405 is electrically connected to the signal transmitting end 502 of the Bluetooth earphone 50 via the signal connector 406 so as to charge the Bluetooth earphone 50, while the Bluetooth earphone 50 is inserted in the base body 401.

Further, after the Bluetooth earpiece 40 with two-way audio transmissions is combined with the Bluetooth earphone 50, the audio information of an incoming call received by a remote mobile phone (not labeled in the figure) is amplified by the internal loudspeaker unit 403 of the Bluetooth earphone 50 to allow users to hear clearly. At the same time, the Bluetooth earpiece 40 further uses an audio signal capture unit 404 to send the audio information replies made by several parties to the Bluetooth earphone 50, and the Bluetooth earphone 50 sends the information to a remote mobile phone (not labeled in the figure) to complete a two-way sound transmission. Therefore, users can use the Bluetooth earpiece 40 with two-way audio transmissions to accomplish a telephone communication for three or more parties and electrically charge the Bluetooth earphone 40 at the same time. The invention provides many applications to improve the quality and requirement of telephone communications for daily life and work.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A Bluetooth earpiece with two-way audio transmission, integrated with a Bluetooth earphone and comprising:
a base body, having an earphone receiving slot for containing said Bluetooth earphone, wherein said Bluetooth earphone has a signal transmitting end, an audio transmission switching unit and an metallic element;
a magnetic element in said earphone receiving slot, said magnetic element attracts said metallic element of said Bluetooth earphone when said Bluetooth earphone approaches said earphone receiving slot;
an amplifying unit, installed in said base body and coupled with said signal transmitting end of said Bluetooth earphone via a signal connector when said Bluetooth earphone is inserted in said earphone receiving slot of said base body;
a loudspeaker unit, installed in said base body and electrically coupled with said amplifying unit; and
an audio signal capture unit, installed in said base body and electrically coupled with said amplifying unit;
wherein said audio transmission switching unit automatically switches the transmission path of said audio information, when said Bluetooth earphone receives audio information from a remote end so as to achieve a two-way audio transmission by said loudspeaker unit and said audio signal capture unit.

2. The Bluetooth earpiece with two-way audio transmission of claim 1, further comprising a battery charging unit installed in said base body, wherein said battery charging unit is electrically coupled with said signal transmitting end of said Bluetooth earphone via the signal connector so as to charge said Bluetooth earphone when said Bluetooth earphone is inserted in said earphone receiving slot of said base body.

3. The Bluetooth earpiece with two-way audio transmission of claim 1, wherein said loudspeaker unit is a speaker.

4. The Bluetooth earpiece with two-way audio transmission of claim 1, wherein said audio signal capture unit is a microphone.
